(19) United States
(12) Patent Application Publication
(10) Pub. No.: US 2026/0339953 A1
(43) Pub. Date: Oct. 29, 2026

(54) ELASTIC PARTITIONING OF METADATA FILES

(71) Applicant: Snowflake Inc., Bozeman, MT (US)

(72) Inventors: Valeri Kim, Sammamish, WA (US); Xinglian Liu, Redmond, WA (US); Yizhi Zhu, Bellevue, WA (US)

(21) Appl. No.: 19/190,001

(22) Filed: Apr. 25, 2025

(51) Int. Cl. G06F 16/2453; G06F 16/22; G06F 16/27

(52) U.S. Cl. CPC G06F 16/24549; G06F 16/221; G06F 16/24544; G06F 16/278

(57) ABSTRACT

The subject technology receives a query that references one or more columns of a database table. The subject technology reads a primary metadata file, including file metadata for data partitions and column group metadata that maps columns to column groups. The subject technology determines whether statistics for one or more columns are available in the primary metadata file. The subject technology, in response to determining that statistics for at least one referenced column are not available in the primary metadata file, uses the column group metadata to identify a secondary metadata file including the statistics for at least one referenced column. The subject technology reads the identified secondary metadata file. The subject technology performs, using the statistics from the primary metadata file and the secondary metadata file, an optimization of the query to improve a subsequent execution of the query.

### TECHNICAL FIELD

The present disclosures relate to database management systems and, in some examples, to algorithms and systems to optimize query compilation through at least partitioning of metadata files for improved performance.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (R DBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a cloud data platform, in accordance with some embodiments of the present disclosure

FIG. 2 is a block diagram illustrating components of a compute service manager of the cloud data platform, in accordance with some embodiments of the present disclosure.

FIG. 3 illustrates an example of an architecture for storing delta EP file metadata and 2-level EP file metadata, in accordance with an embodiment of the subject technology.

FIG. 4 illustrates an example of elastic partitioning for metadata files in accordance with an embodiment of the subject technology.

FIG. 5 illustrates an example of compact EP file partitioning, in accordance with an embodiment of the subject technology.

FIG. 6 illustrates an example of elastic partitioning for metadata files in which column groups are organized across multiple EP (Extended Properties) files, in accordance with an embodiment of the subject technology.

FIG. 7 illustrates an example of “special column groups” in the elastic partitioning approach, in accordance with an embodiment of the subject technology.

FIG. 8 is a flow diagram illustrating operations of a database system in performing a method, in accordance with some embodiments of the present disclosure.

FIG. 9 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Database systems rely on metadata files to store statistics about data partitions for query optimization, but traditional horizontal-only partitioning approaches face significant limitations. As tables grow in width and more sophisticated statistics are added, systems must download metadata for all columns even when queries reference only a subset, creating unnecessary network traffic and storage consumption. Adding heavyweight statistics like HyperLogLog sketches can significantly increase metadata file size, degrading performance even for queries that don't need these statistics. Size limitations of metadata files further constrain the ability to add new statistics or support wide tables. These challenges have prompted the development of elastic partitioning, which combines horizontal partitioning with unaligned vertical partitioning to optimize metadata access and storage for modern database workloads.

Database systems utilize metadata files to store statistics about data partitions. These statistics help optimize query execution by providing information such as minimum and maximum values, null counts, and distinct value counts for each column. In traditional database architectures, metadata files are horizontally partitioned based on groups of data rows.

The described examples address limitations in how metadata files are organized and accessed during query compilation. When a database system compiles a query, it needs to download and process metadata files to determine the most efficient execution plan. However, with the current horizontal partitioning approach, the system must download metadata for all columns in a table, even if only a few columns are referenced in the query. This creates unnecessary network traffic and consumes local disk cache storage, especially for tables with many columns.

Additionally, as databases evolve, there is a need to store more sophisticated statistics in metadata files. For example, HyperLogLog (HLL) sketches for estimating the number of distinct values can increase metadata file size by 20%-80%. Without a way to selectively download these statistics, query performance suffers even when the additional statistics are not needed.

The described examples introduce elastic partitioning of metadata files, which combines horizontal partitioning with unaligned vertical partitioning. In this approach, metadata files are divided not only by groups of data rows (horizontal partitioning) but also by columns (vertical partitioning). The vertical partitioning is “unaligned,” meaning different horizontal partitions can have different vertical partitioning schemes based on size, logic, and partitioning policies.

The architecture designates a primary column group that contains essential metadata needed for all queries, such as file metadata and column group metadata. Additional column groups store statistics that are either larger in size or less frequently used. During query compilation, the system first loads the primary column group metadata file. If the query requires statistics not found in the primary group, the system uses the column group metadata to locate and load the necessary secondary metadata files.

For example, when processing a query with a date filter (e.g., data after January 2025), the system first loads the primary metadata file containing minimum and maximum values for the date column. This allows the system to automatically filter out data partitions where the maximum date is before January 2025, without loading the actual data. If more specialized statistics are needed, such as HLL sketches for estimating distinct values, the system can load those from secondary metadata files only when required.

The elastic partitioning process can occur during metadata file compaction. In database systems, small delta metadata files are created during data manipulation operations. A background process called an metadata file compactor periodically combines these delta files into larger compact metadata files. During this compaction process, the system now also performs vertical partitioning based on column grouping policies.

The implementation includes several components:
1. Column Group Metadata: Stored in the primary column group metadata file, this contains information about which columns belong to which column groups and how to locate secondary column group metadata files.
2. Primary Column Group: Contains essential metadata needed for all queries, including file metadata and column group metadata. This group is always loaded during query compilation.
3. Secondary Column Groups: Store less frequently used or larger statistics. These groups are loaded only when needed.
4. Special Column Groups: Dedicated groups for storing specific types of statistics, such as HLL sketches or N-grams, which are substantially larger than standard statistics.

The elastic partitioning approach offers several advantages. First, it reduces the amount of metadata that needs to be downloaded and processed during query compilation, improving performance for queries that reference only a subset of columns. Second, it allows for the addition of new, potentially larger statistics without impacting the performance of queries that don't need those statistics.

The implementation affects various components of the database system:
1. Query Compilation: The compiler now checks if requested column statistics are in the primary column group. If not, it uses the column group metadata to locate and load the necessary secondary metadata files.
2. Metadata File Compaction: The compaction process now includes logic for column grouping and vertical partitioning.
3. Replication: When replicating metadata between database instances, the system needs to handle the new vertically partitioned metadata structure.
4. Data Consistency Checking: Processes that validate data consistency need to be updated to work with the new metadata organization.

The elastic partitioning of metadata files represents a significant enhancement to database metadata management, addressing performance challenges associated with growing metadata size and complexity while maintaining compatibility with existing database operations.

In database systems, performing transactions on a given database can be supported. To facilitate that a given transaction is committed to a table, existing database systems can employ varying approaches including Online Transactional Processing (OLTP) techniques. OLTP refers to a category of data processing that involves transaction-oriented tasks. In an example, OLTP involves inserting, updating, and/or deleting varying amounts of data in a given database. OLTP can deal with large numbers of transactions by a large number of users. In some example embodiments, an OLTP database can be implemented as a key-value database in which the data is managed as key-value pairs (e.g., FoundationDB). Increasingly, such transactions are implemented by users who are working in a distributed and networked environment from varying locations and computing environments. Thus, it is also increasingly important to ensure such transactions are executed and completed in a concurrent manner that protects the integrity and consistency of the data in such a distributed environment.

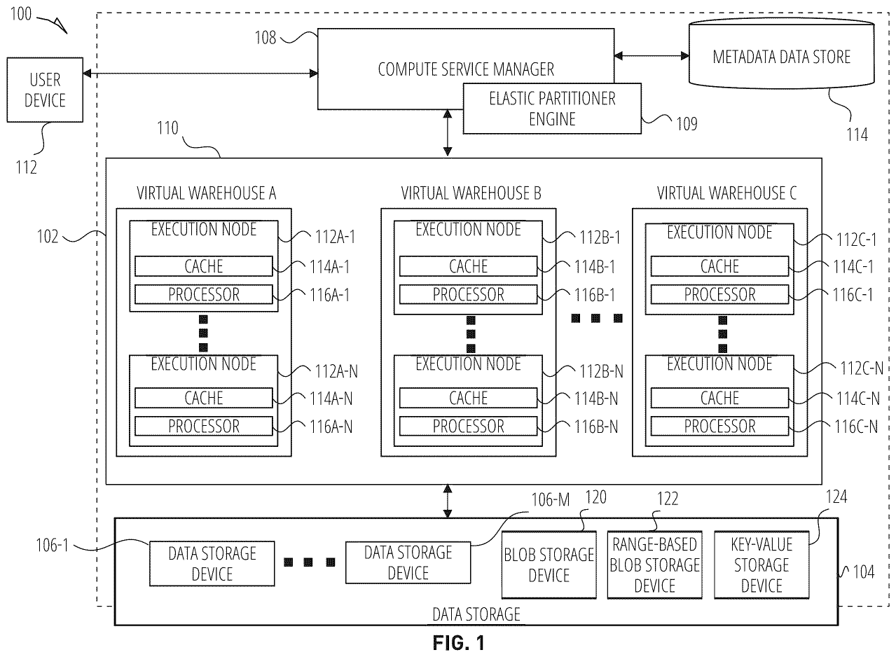

FIG. 1 illustrates an example computing environment 100 that includes a data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a three-tier architecture: a compute service manager 108 coupled to a metadata data store 114, an execution platform 110, and data storage 104. The data platform 102 hosts and provides data access, management, reporting, and analysis services to multiple client accounts. Administrative users can create and manage identities (e.g., users, roles, and groups) and use permissions to allow or deny access to the identities to resources and services. The data platform 102 is used for reporting and analysis of integrated data from one or more disparate sources including storage devices within the data storage 104. The data storage 104 comprises a plurality of computing machines and provides on-demand computer system resources such as data storage and computing power to the data platform 102.

The compute service manager 108 includes multiple services that coordinate and manage operations of the data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

As shown, the compute service manager 108 includes an elastic partitioner engine 109 that is responsible for elastic partitioning. Further details of the operation of the elastic partitioner engine 109 are discussed below.

The compute service manager 108 is also in communication with a user device 112. The user device 112 corresponds to a user of one of the multiple client accounts supported by the data platform 102. In some implementations, the compute service manager 108 does not receive any direct communications from the user device 112 and only receives communications concerning jobs from a queue within the data platform 102.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution node 112A-1 to 112A-N ; execution node 112A-1 includes a cache 114A-1 and a processor 116A-1; and execution node 112A-N includes a cache 114A-N and a processor 116A-N. Similarly, in this example, virtual warehouse B includes execution node 112B-1 to 112B-N ; execution node 112B-1 includes a cache 114B-1 and a processor 116B-1; and execution node 112B-N includes a cache 114B-N and a processor 116B-N. Additionally, virtual warehouse C includes execution node 112C-1 to 112C-N; execution node 112C-1 includes a cache 114C-1 and a processor 116C-1; and execution node 112C-N includes an execution node 112C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the data storage devices 106-1 to 106-M are managed and provided by a third-party data storage platform (e.g., AWS®, Microsoft Azure Blob Storage®, or Google Cloud Storage®).

Further, data storage 104 comprises blob storage device 120 (e.g., storing data in a micro-partition format of an OLAP database), range-based blob storage device 122 (e.g., storing blob of data, each blob corresponding to a range granule), and key-value storage device 124 (e.g., storing key-value pair data of a OLTP database). In some example embodiments, key-value data (e.g., OLTP data) is replicated from the key-value storage device 124 to the blob storage device 120. In some embodiments, the data storage devices of the data storage 104 are cloud-based storage devices located in one or more geographic locations. For example, the data storage devices may be part of a public cloud infrastructure or a private cloud infrastructure.

At a high level, analytical style data (e.g., OLAP data) is stored and managed using the blob storage device 120 (e.g., partitions of data are stored in blob storage device 120) and metadata storage to track the partition data (e.g., metadata data store 114, key-value storage device 124 having key-value based metadata to track the partitions), where compute service manager 108 and the execution platform (e.g., execution nodes 112A-N) perform writes and reads of the blob storage device 120 in response to analytical style queries (e.g., OLAP queries), in accordance with some example embodiments

In an implementation, range-based blob storage device 122 operates in a hybrid OLTP system that can function as an OLTP database for small transactions (e.g., point lookups) and provide results for large reads (e.g., OLTP style reads) using the range-based blob storage device 122, where the execution platform 110 (e.g., a plurality of compute instances instantiated on the client side) receives pointer data for the large reads from a blob system, and the execution platform 110 then performs the read request by pulling data from the range-based blob storage device 122. In some example embodiments, the range-based blob storage device 122 is configured differently than the blob storage device 120 in that range-based blob storage device 122 is kept transactionally consistent with the transactional OLTP data in the key-value storage device 124. The range-based blob storage device 122 is further different than the blob storage device 120 in that it is strictly range partitioned to provide large reads against OL TP data.

Each virtual warehouse can access any of the data storage devices 106-1 to 106-M, blob storage device 120, range-based blob storage device 122, key-value storage device 124 shown in FIG. 1. Thus, the virtual warehouses are not necessarily assigned to a specific data storage device 106-1 to 106-M, blob storage device 120, range-based blob storage device 122, key-value storage device 124, and, instead, can access data from any of the data storage devices 106-1 to 106-M, blob storage device 120, range-based blob storage device 122, key-value storage device 124, within the data storage 104. Similarly, each of the execution nodes shown in FIG. 1 can access data from any of the data storage devices 106-1 to 106-M, blob storage device 120, range-based blob storage device 122, and key-value storage device 124. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M, blob storage device 120, range-based blob storage device 122, key-value storage device 124 are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 114, execution platform 110, and data storage 104 are shown in FIG. 1 as individual discrete components. However, each of the compute service manager 108, metadata data store 114, execution platform 110, and data storage 104 may be implemented as a distributed system (e.g., distributed across multiple systems/platforms at multiple geographic locations). Additionally, each of the compute service manager 108, metadata data store 114, execution platform 110, and data storage 104 can be scaled up or down (independently of one another) depending on changes to the requests received and the changing needs of the data platform 102. Thus, in the described embodiments, the data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M, blob storage device 120, range-based blob storage device 122, key-value storage device 124 in the data storage 104. Thus, the computing resources and cache resources are not restricted to specific data storage devices 106-1 to 106-M, blob storage device 120, range-based blob storage device 122, key-value storage device 124. Instead, all computing resources and all cache resources may retrieve data from, and store data to, any of the data storage resources in the data storage 104.

As mentioned further herein, terms “file” and “micro-partition” or partition may each refer to a subset of database data and may be used interchangeably in some embodiments. The file metadata includes information about a micro-partition of the table. Further, metadata may be stored for each column of each micro-partition of the table. The metadata pertaining to a column of a micro-partition may be referred to as an expression property (EP) and may include any suitable information about the column, including for example, a minimum and maximum for the data stored in the column, a type of data stored in the column, a subject of the data stored in the column, versioning information for the data stored in the column, file statistics for all micro-partitions in the table, global cumulative expressions for columns of the table, and so forth. Each column of each micro-partition of the table may include one or more expression properties. It should be appreciated that the table may include any number of micro-partitions, and each micro-partition may include any number of columns. The micro-partitions may have the same or different columns and may have different types of columns storing different information. As discussed further herein, the subject technology provides a file system that includes “EP” files (expression property files), where each of the EP files stores a collection of expression properties about corresponding data. As described further herein, each EP file (or the EP files, collectively) can function similar to an indexing structure for micro-partition metadata. Stated another way, each EP file includes a “region” of micro-partitions, and the EP files are the basis for persistence, cache organization and organizing the multi-level structures of a given table's EP metadata. Additionally, in some implementations of the subject technology, a two-level data structure (also referred to as “2-level EP” or a “2-level EP file”) can at least store metadata corresponding to grouping expression properties and micro-partition statistics.

As mentioned above, a table of a database may include many rows and columns of data. One table may include millions of rows of data and may be very large and difficult to store or read. A very large table may be divided into multiple smaller files corresponding to micro-partitions. For example, one table may be divided into six distinct micro-partitions, and each of the six micro-partitions may include a portion of the data in the table. Dividing the table data into multiple micro-partitions helps to organize the data and to find where certain data is located within the table.

In an embodiment, the metadata data store 114 includes EP files (expression property files), where each of the EP files store a collection of expression properties about corresponding data. As mentioned before, EP files provide a similar function to an indexing structure into micro-partition metadata. Metadata may be stored for each column of each micro-partition of a given table.

In an example, a large source table may be (logically) organized as a set of regions in which each region can be further organized into a set of micro-partitions. Additionally, each micro-partition can be stored as a respective file in the subject system in an embodiment. Thus, the term “file” (or “data file”) as mentioned herein can refer to a micro-partition or object for storing data in a storage device or storage platform. In embodiments herein, each file includes data, which can be further compressed (e.g., using an appropriate data compression algorithm or technique) to reduce a respective size of such a file.

In some embodiments, metadata may be generated when changes are made to one or more source table(s) using a data manipulation language (DM L), where such changes can be made by way of a DM L statement. Examples of modifying data, using a given DM L statement, may include updating, changing, merging, inserting, and deleting data into a source table(s), file(s), or micro-partition(s).

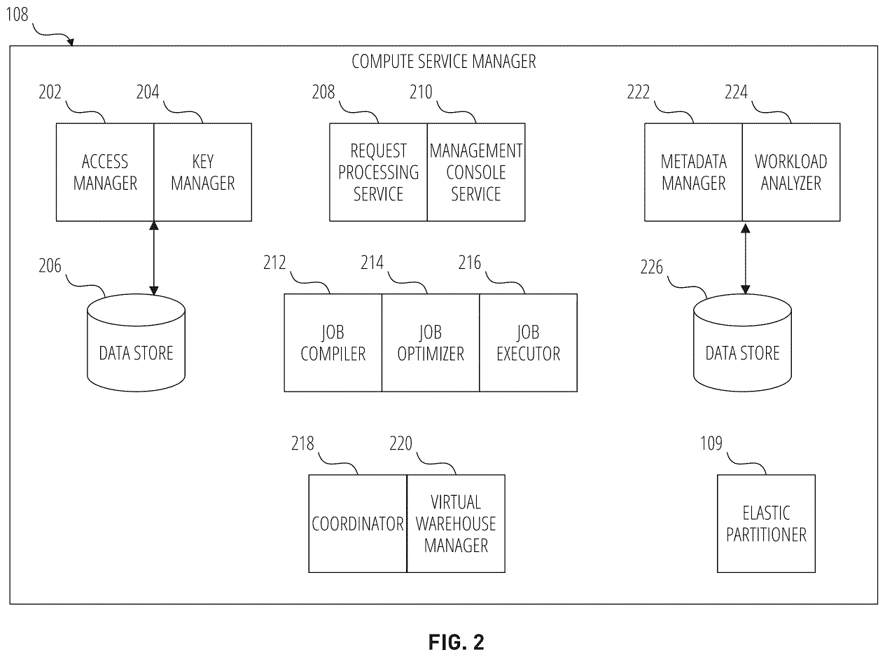

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the data platform 102. For example, data store 226 may represent caches in execution platform 110, storage devices in data storage 104, the metadata data store 114, or any other storage device or system.

In addition, as mentioned above, the compute service manager 108 includes an elastic partitioner engine 109 that is responsible for elastic partitioning. Further details regarding the functionality of the elastic partitioner engine 109 are discussed below.

Storing additional statistics or metadata (e.g., extended or expression properties collectively referred to as “EPs”) for each column of data increases the size of metadata files, which leads to higher compilation latency due to the time required to download and read these files. As more statistics are added, the metadata files grow larger, creating performance bottlenecks during query compilation.

In an existing approach, column statistics (e.g., EPs) are stored together in a single file for a group of data rows. This horizontal-only partitioning meant that the file was downloaded in its entirety, but not loaded as a whole, while column base loading being performed during query compilation. In an example, the partitioning scheme, as described further herein, reduces the file size and therefore does not add overhead when downloading. In yet another example, an existing horizontal-only partitioning meant that all statistics for all columns had to be loaded during query compilation, regardless of which columns were actually referenced in the query, and the file was downloaded in its entirety.

Embodiments described herein provide an elastic approach for metadata file partitioning, which provides several key advantages:
1. Reduced Metadata Loading: Only the primary EP file is always downloaded. Secondary EP files containing less frequently used statistics are loaded on demand only when needed, significantly reducing the amount of metadata processed during query compilation.
2. Overcoming Size Limitations: Metadata files have size constraints, and increasing the number of statistics would reduce the number of rows that can be covered by a single file. Elastic partitioning removes this limitation by distributing statistics across multiple files based on usage patterns.
3. Efficient Handling of Large Statistics: Some statistics such as text search prefix tries are much larger than others (e.g., min/max values) and are only needed for specific query types. Elastic partitioning stores these large statistics separately, preventing them from impacting performance when not needed. A trie refers to a specialized tree-based data structure used for efficient retrieval of keys, particularly for string or text data.

In an implementation, the techniques disclosed herein are based on storing a dictionary in the primary EP file that includes information on how to locate secondary EP files for statistics not present in the primary EP file. This approach enables selective loading of metadata based on query requirements.

For a table with a string column storing statistics including minimum value, maximum value, and text search prefix trie:
Min/max values are small and frequently used for queries with predicates on the column
Text search prefix trie is a large data structure useful for text search predicates
With elastic partitioning, min/max values are stored in the primary EP file while the text search prefix trie is stored in a secondary EP file
The secondary file is only loaded when a query contains text search predicates, avoiding unnecessary overhead for other query types

For example, the techniques described herein improve query compilation performance, especially for tables with many columns or specialized statistics, by reducing the amount of metadata that needs to be downloaded and processed. As a result, improvements in the functioning of a computer are provided.

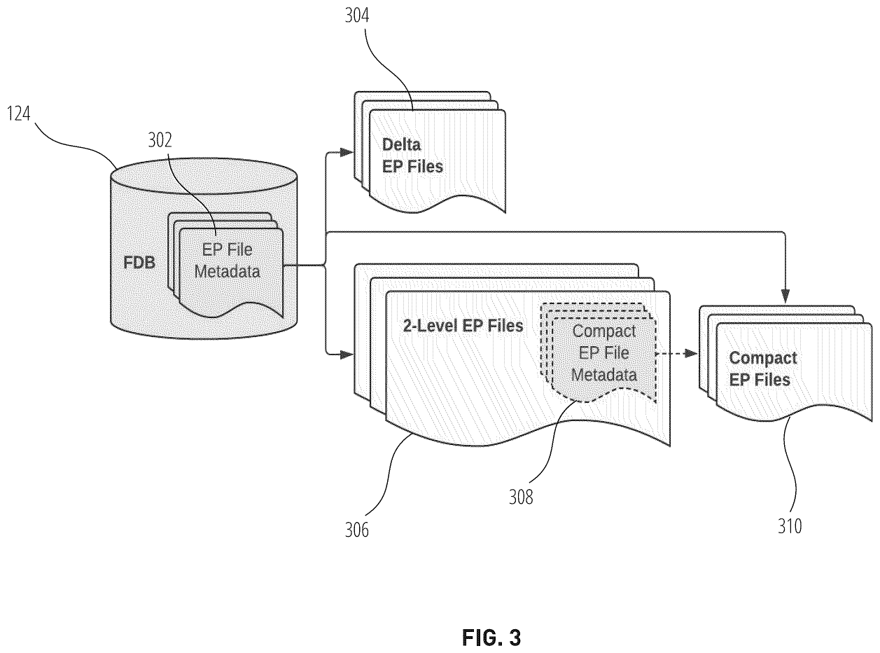

FIG. 3 illustrates an example of an architecture for storing delta EP file metadata and 2-level EP file metadata, in accordance with an embodiment of the subject technology.

In this architecture, EP file metadata 302 includes both delta EP file metadata and 2-level EP file metadata (e.g., corresponding to delta EP files 304 and two-level EP files 306) that are stored in key-value storage device 124 (e.g., FDB (FoundationDB)), while compact EP file metadata 308 is also stored in two-level EP files 306. This is illustrated in the diagram showing the relationship between delta EP files, FDB (containing EP file metadata), 2-Level EP files, and compact EP files 310.

The existing approach accumulates file metadata and column EPs for each data partition in memory until either the end of the transaction or until the uncompressed size of the collection reaches a limit of 10 MB (DML_MAX_FILE_CACHE_SIZE). At that point, the entire collection is compressed and persisted into a delta EP file.

During compaction, a similar horizontal partitioning approach is employed by the background EP file compactor. When delta EP files are concatenated, once the uncompressed size of the collection reaches a limit of 16 MB (EPS3_CONCAT_MAX_FILE_SIZE), the collection is compressed and persisted into a compact EP file.

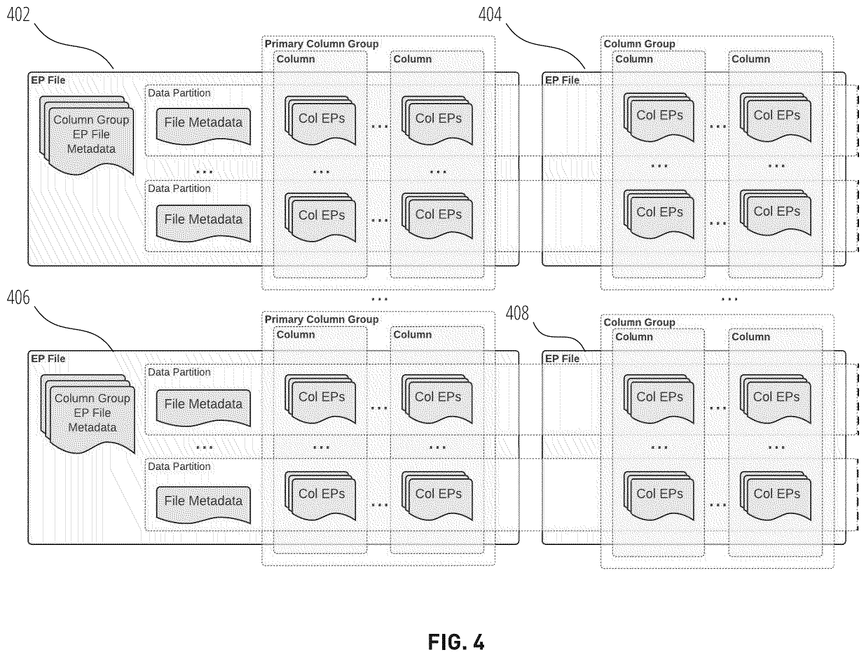

FIG. 4 illustrates an example of elastic partitioning for metadata files in accordance with an embodiment of the subject technology. M ore specifically, FIG. 4 shows a visual representation of how column groups are organized across multiple EP files, including EP file 402, EP file 404, EP file 406, and EP file 408.

The diagram in FIG. 4 depicts two main column group structures:
1. Primary Column Group: Shown on the left side in EP file 402 and EP file 406, including:
   Column Group EP File Metadata
   File Metadata for data partitions
   Column EPs (Extended Properties/statistics) for selected columns
2. Secondary Column Group: Shown on the right side, in EP file 404 and EP file 408 including:
   Column EPs for additional columns not included in the primary group

In the example of FIG. 4, data partitions are horizontally aligned across both the primary and secondary column groups. Each horizontal row represents a data partition, with the primary column group containing essential metadata and the secondary column group containing additional column statistics that are loaded only when needed.

FIG. 4 further visually emphasizes one of the key concepts of elastic partitioning: while metadata files are partitioned horizontally based on data partitions (shown as horizontal rows), they are also partitioned vertically based on columns (shown as the separation between primary and secondary column groups). This allows the subject system (e.g., elastic partitioner engine 109) to load only the necessary metadata for a given query, reducing network traffic and local storage usage.

FIG. 4 also illustrates how the column group EP file metadata stored in the primary column group enables the subject system (e.g., elastic partitioner engine 109) to locate the appropriate secondary metadata files when statistics for specific columns are requested during query compilation.

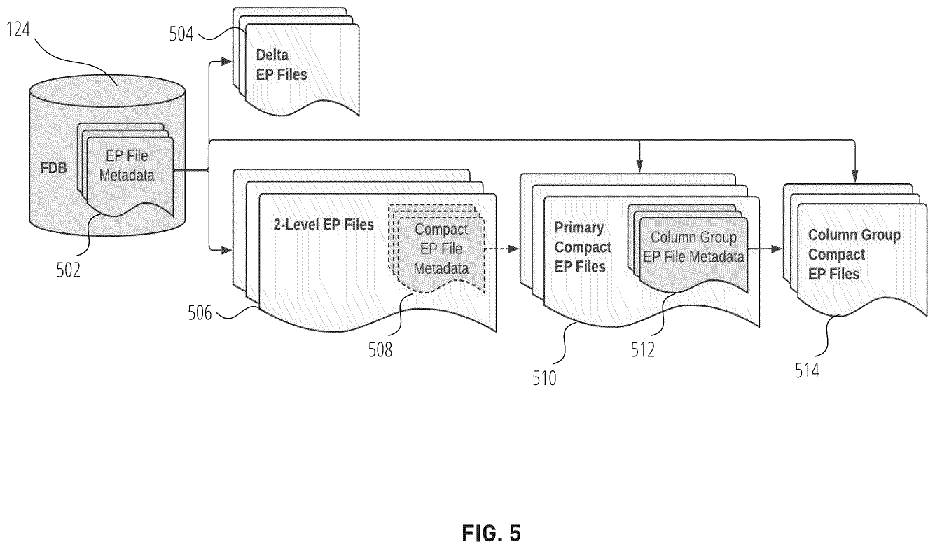

FIG. 5 illustrates an example of compact EP file partitioning, in accordance with an embodiment of the subject technology.

As shown, EP file metadata 502 is stored in key-value storage device 124, where EP file metadata 502 includes delta EP files 504 and two-level EP files 506. During delta EP file compaction operations of delta EP files 504, the subject system aggregates and concatenates all extended properties from EP file metadata 502 (e.g., delta EP files 504 and two-level EP files 506) into a unified continuous batch prior to repartitioning and persistence into compact EP files (e.g., primary compact EP files 510) that store compact EP file metadata 508. This compaction process incorporates vertical partitioning capabilities with the horizontal partitioning implementation, taking into consideration both the maximum permissible column group size and specialized columns requiring dedicated column group allocation.

In an implementation, a maximum column group size is determined via a configurable parameter (e.g., a maximum size threshold), whereby all columns undergo distribution across multiple column groups such that no individual column group exceeds the specified maximum size threshold. This distribution mechanism may implement various algorithmic strategies to optimize column group composition with respect to resultant EP file sizes. As discussed in subsequent sections related to EP retrieval operations, it is advantageous for this distribution to position frequently accessed columns within the primary column group (such as VARIANT columns and their associated subcolumn EPs).

Upon flushing the batch into EP files, the subject system persists column group EP file metadata 512 within primary compact EP files 510. This column group EP file metadata 512 encapsulates the mapping relationship between columns and their respective column group EP files from column group compact EP files 514. The implementation of separate flushing operations for each column group potentially enhances both computational performance and memory utilization efficiency during compaction procedures, particularly for database tables characterized by substantial column counts.

The proposed extended properties (EP) file partitioning architecture can also implement an unaligned vertical partitioning approach, where different compact EP files may organize columns into entirely distinct grouping configurations. This non-alignment characteristic offers several technical advantages:
1. Optimized Column Group Composition: The system can implement column grouping strategies tailored to the specific data distribution patterns of each EP file. This flexibility enables dynamic optimization of column groups based on statistical properties, access patterns, and data characteristics unique to each partition, resulting in more efficient metadata organization and retrieval.
2. Simplified Schema Evolution: When database tables undergo structural modifications through the addition or removal of columns, the unaligned approach eliminates the need to reorganize existing metadata files. Registration requests from data manipulation language (DML) operations executed before and after such schema changes can contain completely different column sets. The resulting EP files may consequently have different column groups, but this variation poses no architectural challenge since column groups can inherently differ even within the same batch of file registration requests.
3. Enhanced Subcolumn EP Management: The unaligned vertical partitioning simplifies the handling of subcolumn extended properties, particularly for semi-structured data types such as VARIANT columns. This approach provides greater flexibility in organizing and accessing the potentially numerous subcolumn statistics generated for variant data paths, allowing for more efficient storage and retrieval of these specialized extended properties.

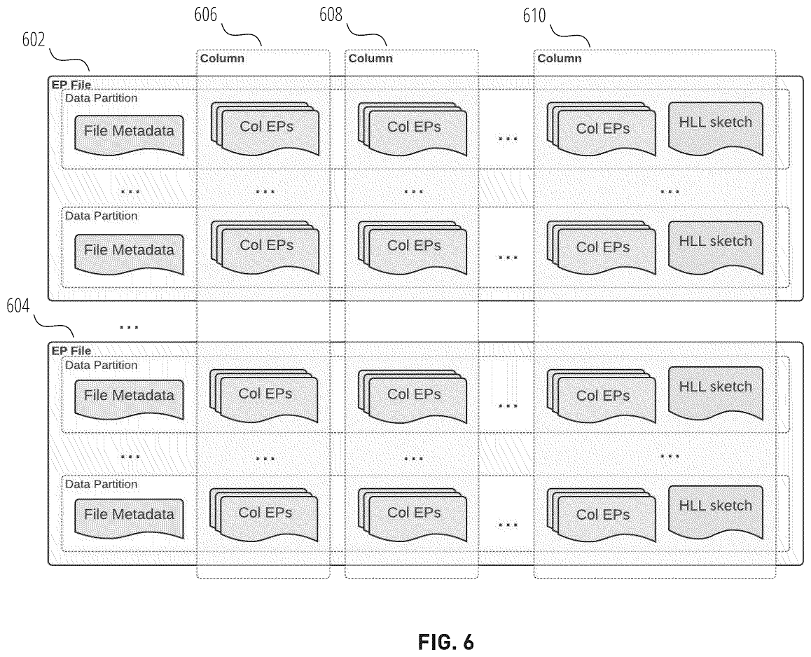

FIG. 6 illustrates an example of elastic partitioning for metadata files in which column groups are organized across multiple EP (Extended Properties) files, in accordance with an embodiment of the subject technology.

In the example of FIG. 6, EP file 602 and EP file 604 include the following:
1. Primary Column Group: shown on the left side, including:
   File metadata for data partitions
   Column EP Metadata (sub)group (represented by column 606 and column 608), which includes column EPs (extended properties/statistics) for their respective column
2. Secondary Column Group: shown on the right side, including:
   column 610, including column EPs for each data partition corresponding to additional metadata not included in the primary column group
   a respective HLL (HyperLogLog) sketch for each data partition

FIG. 6 shows how the subject system (e.g., elastic partitioner engine 109) can organize data partitions to have them horizontally aligned across both the primary and secondary column groups. Each horizontal row represents a data partition, with the primary column group including essential metadata and the secondary column group containing additional column statistics and HLL sketches.

In an implementation, file metadata for each data partition includes mapping information about which columns belong to which column groups and how to locate the corresponding column group EP files. In an example, this mapping enables the subject system to find and load the appropriate secondary metadata files when statistics for specific columns are requested during query compilation.

An HLL (HyperLogLog) sketch, as mentioned herein, is a probabilistic data structure used for estimating the number of distinct values in a dataset. In the context of the elastic partitioning, HLL sketches are substantially larger than standard column statistics, increasing metadata file size by 20%-80% compared to other EPs (Extended Properties) persisted in EP files.

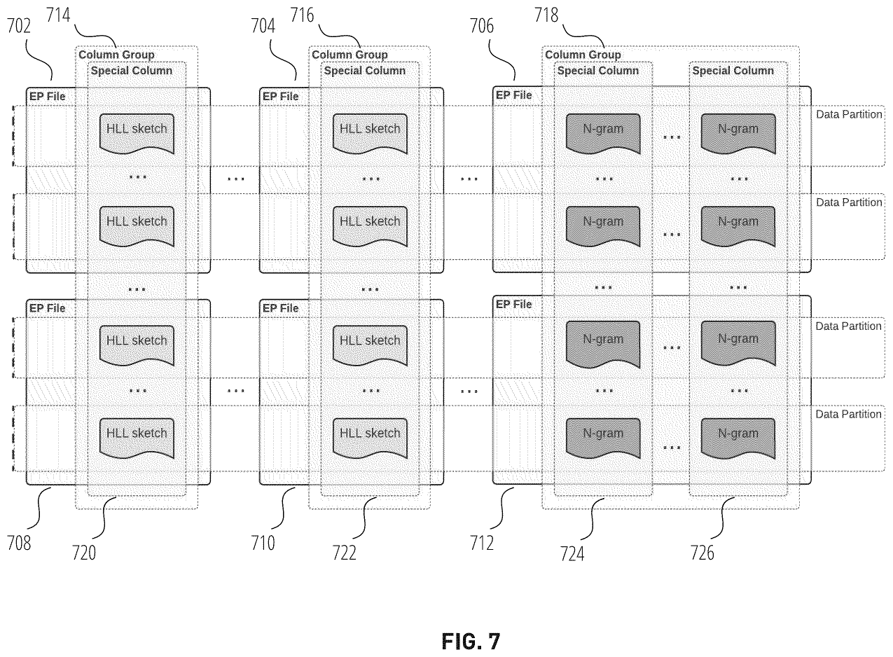

FIG. 7 illustrates an example of “special column groups” in the elastic partitioning approach, in accordance with an embodiment of the subject technology.

In the example of FIG. 7, the subject system (e.g., elastic partitioner engine 109) can organize specialized statistics (e.g., HLL sketches) that are 1) larger in size or 2) less frequently used such that they are stored separately from regular column statistics.

In an implementation, the elastic partitioning approach (e.g., provided by elastic partitioner engine 109) stores HLL sketches separately from other column statistics, allowing them to be loaded only when specifically needed for query optimization (such as when a query includes a COUNT(DISTINCT column_name) operation), preventing performance degradation for queries that don't require this specialized statistic.

In the example of FIG. 7, each EP file 702, EP file 704, EP file 706, EP file 708, EP file 710, and EP file 712 is included in one of three column groups across different data partitions:
1. column group 714, including special column 720 that stores a set of HLL sketches, where each data partition includes a respective HLL sketch
2. column group 716, including special column 722 that stores another set of HLL sketches, where each data partition includes a respective HLL sketch
3. column group 718 including special column 724 and special column 726 that each store statistics from N-grams

Each column group is shown as a vertical arrangement of EP files, with each EP file containing statistics for multiple data partitions. The data partitions are aligned horizontally across all column groups, maintaining consistency in how data is organized.

This figure demonstrates how specialized statistics like HLL sketches (used for distinct value estimation) and N-grams (used for text search optimization) are stored in dedicated special column groups rather than alongside regular column statistics. This separation allows these larger statistics to be loaded only when specifically needed for query optimization, preventing them from impacting performance when not required.

In an implementation, the special column approach can use a SpecialColumnSourceIdEnum with a reserved range for special columns used to store additional statistics. This enables the subject system (e.g., elastic partitioner engine 109) to support an expanding set of specialized statistics without degrading performance for queries that does not require those statistics.

The loading of extended properties (EP) files incorporates an additional processing step. Following the initial loading of EP file metadata from the foundational database (FDB), the system examines each loaded file to determine whether the requested column resides in the primary column group through consultation of the column group metadata within the metadata files. The column group metadata loading occurs lazily, similar to other properties such as row count and file master key identifier, to minimize overhead when processing files containing only a single column group. In an example, the column group metadata is cached, similar to other metadata properties, such that the column group metadata is not needed to be loaded repeatedly. A boolean indicator in FDB designates whether each EP file maintains all table columns (excluding special columns) within the primary column group.

When a requested column is not found in the primary column group, the system loads and examines the column group metadata to identify the appropriate column group EP file. The horizontal alignment of EP file partitioning maintains consistency in loading and accessing primary column group EP files. Extended properties across all column group EP files maintain identical ordering, ensuring consistent EP offsets between primary and secondary column group EP files.

Schema modifications involving column additions or removals do not impact the proposed architecture due to the unaligned nature of EP file partitioning. Data manipulation language (DML) registration requests executed before and after such schema changes may contain different column sets, resulting in EP files with varying column groups. This variation is accommodated by the design's support for different column groups within a single batch of file registration requests.

The initial cloning process, which involves replication of EP file metadata stored in FDB, remains unaffected by the EP file partitioning architecture. The subject system replicates metadata for primary column group EP files while maintaining existing column group EP file metadata. Subsequent data manipulation operations on clones generate registration requests specific to the clone, avoiding impact on the source table. In an example, the column group metadata stored in the primary EP file is table anonymous in the sense that it is not needed to rewrite the column group metadata, which results in the primary EP file also not being rewritten during cloning.

In an example, when a secondary instance requests a version delta from the primary instance, the system generates extended properties for the version delta and transmits them as delta EP files without vertical partitioning. The secondary instance processes these files similarly to data partition registration requests, implementing both horizontal and vertical partitioning during the processing of new EP files, consistent with the compact EP file partitioning approach.

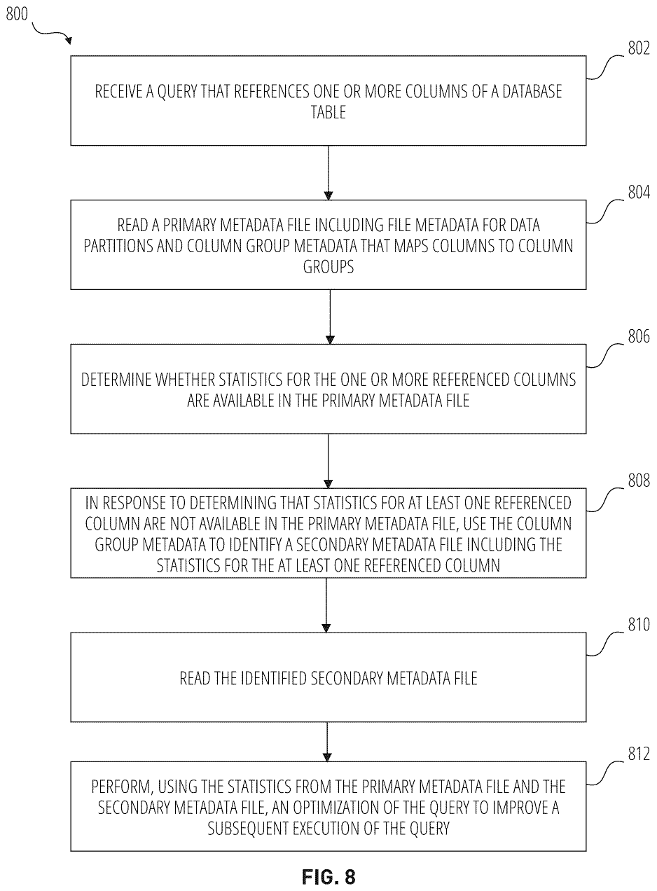

FIG. 8 is a flow diagram illustrating operations of a database system in performing a method, in accordance with some embodiments of the present disclosure. The method 800 may be embodied in computer-readable instructions for execution by one or more hardware components (e.g., one or more processors) such that the operations of the method 800 may be performed by components of data platform 102 (e.g., elastic partitioner engine 109). Accordingly, the method 800 is described below, by way of example with reference thereto. However, it shall be appreciated that method 800 may be deployed on various other hardware configurations and is not intended to be limited to deployment within the data platform 102.

According to some examples, the method 800 includes receiving a query that references one or more columns of a database table at operation 802.

According to some examples, the method 800 includes reading a primary metadata file including file metadata for data partitions and column group metadata that maps columns to column groups at operation 804.

According to some examples, the method 800 includes determining whether statistics for the one or more referenced columns are available in the primary metadata file at operation 806.

According to some examples, the method 800 includes in response to determining that statistics for at least one referenced column are not available in the primary metadata file, using the column group metadata to identify a secondary metadata file including the statistics for the at least one referenced column at operation 808.

According to some examples, the method 800 includes reading the identified secondary metadata file at operation 810.

According to some examples, the method 800 includes performing, using the statistics from the primary metadata file and the secondary metadata file, an optimization of the query to improve a subsequent execution of the query at operation 812.

In an example, the subject system uses statistics from metadata files to optimize query execution in several key ways. When a query includes filter conditions, such as filtering data after a specific date, the system uses minimum and maximum values from column statistics to automatically eliminate data partitions that cannot satisfy the conditions, significantly reducing the amount of data that needs to be processed.

For more complex operations, the system loads specialized statistics from secondary metadata files as needed. For example, HLL sketches are loaded for distinct value estimation in COUNT(DISTINCT) operations, text search prefix tries optimize text search predicates, and Bloom filters help optimize join operations by quickly filtering potential matches.

The optimization process is particularly efficient because the elastic partitioning approach allows the subject system to selectively load only the statistics needed for specific query operations. For instance, when optimizing queries on VARIANT columns, the subject system loads relevant subcolumn statistics, and for queries with filtering conditions, it loads column properties that help determine optimal access patterns without the overhead of loading unused statistics.

In an example, the method 800 may include generating an optimized query based at least in part on performing the optimization, sending the optimized query to a particular execution node for executing the optimized query.

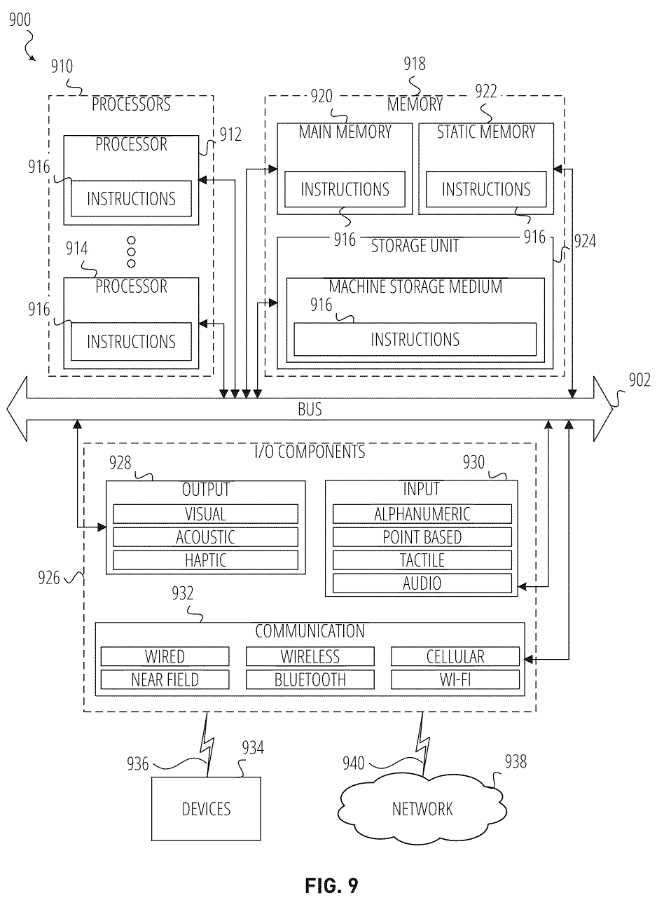

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., a software, a program, an application, an applet, an app, or other executable code) for causing the machine 900 to perform any one or more of the methodologies discussed herein may be executed. For example, the instructions 916 may cause the machine 900 to execute any one or more operations of the method(s) described herein. As another example, the instructions 916 may cause the machine 900 to implement any one or more portions of the functionality illustrated in any one of FIG. 2, FIG. 3 to FIG. 7. In this way, the instructions 916 transform a general, non-programmed machine into a particular machine that is specially configured to carry out any one of the described and illustrated functions of the data platform 102 such as the compute service manager 108 (or a component thereof such as the elastic partitioner engine 109) or an execution node of the execution platform 110.

In some embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines machine 900 that individually or jointly execute the instructions 916 to perform any one or more of the methodologies discussed herein.

The machine 900 includes processors 910, memory 918, and i/o components 926 configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (A SIC), a radio-frequency integrated circuit (RFIC), another processor, or any suitable combination thereof) may include, for example, a processor 914 and a processor 912 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiple cores, or any combination thereof.

The memory 918 may include a main memory 920, a static memory 922, and a storage unit 924, all accessible to the processors 910 such as via the bus 902. The main memory 920, the static memory 922, and the storage unit 924 store the instructions 916 embodying any one or more of the methodologies or functions described herein. The instructions 916 may also reside, completely or partially, within the main memory 920, within the static memory 922, within the storage unit 924, within at least one of the processors 910 (e.g., within the processor's cache memory), or any suitable combination thereof, during execution thereof by the machine 900.

The i/o components 926 include components to receive input, provide output, produce output, transmit information, exchange information, capture measurements, and so on. The specific i/o components 926 that are included in a particular machine 900 will depend on the type of machine. For example, portable machines such as mobile phones will likely include a touch input device or other such input mechanisms, while a headless server machine will likely not include such a touch input device. It will be appreciated that the i/o components 926 may include many other components that are not shown in FIG. 9. The i/o components 926 are grouped according to functionality merely for simplifying the following discussion and the grouping is in no way limiting. In various example embodiments, the i/o components 926 may include output components 928 and input components 930. The output components 928 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 926 may include communication components 932 operable to couple the machine 900 to a network 938 or devices 934 via a coupling 940 and a coupling 936, respectively. For example, the communication components 932 may include a network interface component or another suitable device to interface with the network 938. In further examples, the communication components 932 may include wired communication components, wireless communication components, cellular communication components, and other communication components to provide communication via other modalities. The devices 934 may be another machine or any of a wide variety of peripheral devices (e.g., a peripheral device coupled via a universal serial bus (USB). For example, as noted above, the machine 900 may correspond to any one of the compute service manager 108, the execution platform 110, and the devices 934 may include the data store 206 or any other computing device described herein as being in communication with the data platform 102 or the data storage 104.

The various memories (e.g., memory 918, main memory 920, static memory 922, and/or memory of the processor(s) 910 and/or the storage unit 924) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM) , electrically erasable programmable read-only memory (EEPROM) , field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 938 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 938 or a portion of the network 938 may include a wireless or cellular network, and the coupling 940 may be a Code Division Multiple Access (CDMA) connection, a Global System for Mobile communications (GSM) connection, or another type of cellular or wireless coupling. In this example, the coupling 940 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UM TS), High-Speed Packet Access (HSPA) , Worldwide Interoperability for Microwave Access (WiMAX) , Long Term Evolution (LTE) standard, others defined by various standard-setting organizations, other long-range protocols, or other data transfer technology.

The instructions 916 may be transmitted or received over the network 938 using a transmission medium via a network interface device (e.g., a network interface component included in the communication components 932) and utilizing any one of a number of well-known transfer protocols (e.g., hypertext transfer protocol (HTTP)). Similarly, the instructions 916 may be transmitted or received using a transmission medium via the coupling 936 (e.g., a peer-to-peer coupling) to the devices 934. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of a method may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

The following relates to various explanations of terms or phrases that are referred to herein.

Elastic Partitioning: A metadata file organization approach that combines horizontal partitioning (based on groups of data rows) with unaligned vertical partitioning (based on columns). This approach allows the system to load only the necessary metadata for a given query, reducing network traffic and local storage usage.

Column Group: A logical collection of columns whose statistics are stored together in the same metadata file. Column groups are used to organize metadata vertically, allowing the system to load statistics only for columns that are referenced in a query.

Primary Column Group: The designated first group of columns whose metadata is always loaded during query compilation. In addition to column statistics, the primary column group contains file metadata and column group metadata that maps columns to their respective column groups.

Secondary Column Group: A column group containing statistics for columns not included in the primary column group. Secondary column groups are loaded only when statistics for their columns are needed for query compilation.

Special Column Group: A dedicated column group for storing specific types of statistics that are substantially larger than standard statistics or are rarely used in query compilation, such as HyperLogLog sketches or N-grams.

Metadata File: A file that stores statistics about data partitions, such as minimum and maximum values, null counts, and distinct value information for each column. These statistics are used during query compilation to make optimization decisions.

EP File: Extended or Expression Properties file, a type of metadata file that stores column statistics and file metadata for data partitions.

Delta EP File: A metadata file created during data manipulation operations that contains file metadata and column properties for all columns. Delta EP files are partitioned horizontally only.

Compact EP File: A metadata file created by combining multiple delta EP files during the compaction process. Compact EP files may be partitioned both horizontally and vertically.

Column Group Metadata: Information stored in the primary column group that maps columns to their respective column groups and contains file location references for secondary column groups. This metadata enables the system to locate the appropriate secondary metadata file when statistics for a specific column are requested.

HyperLogLog (HLL) Sketch: A probabilistic data structure used for estimating the number of distinct values in a dataset. HLL sketches are substantially larger than standard column statistics and are stored in dedicated special column groups.

N-gram: A specialized statistic used for text search optimization. N-grams are stored in dedicated special column groups due to their large size and specialized usage.

Bloom Filter: A space-efficient probabilistic data structure used to test whether an element is a member of a set. In the context of database systems, Bloom filters can be used for join optimization and are stored in dedicated special column groups.

Horizontal Partitioning: The division of metadata files based on groups of data rows. Each horizontal partition contains statistics for a specific set of data partitions.

Vertical Partitioning: The organization of metadata by columns, allowing the system to load only the statistics for columns that are referenced in a query.

Unaligned Vertical Partitioning: A form of vertical partitioning where different horizontal partitions may have different vertical partitioning schemes. This flexibility allows the system to optimize column grouping for each horizontal partition based on data distribution and usage patterns.

Metadata File Compaction: The process of combining multiple delta EP files into compact EP files with both horizontal and vertical partitioning. During compaction, columns are grouped based on usage patterns, size of statistics, and predefined policies.

Column Usage Statistics: Data that tracks how frequently each column is used in queries. These statistics may influence column grouping decisions during metadata file compaction, placing frequently accessed columns in the primary column group and less frequently accessed columns in secondary groups.

EP Cache: A component of the query compilation subsystem that loads and caches metadata files locally. The EP cache first loads the primary metadata file and then loads secondary metadata files as needed.

Column Group Resolver: A component of the query compilation subsystem that uses column group metadata to locate the appropriate secondary metadata file when statistics for a specific column are requested.

Unaligned Vertical Partitioning: A metadata organization approach wherein different compact metadata files may organize columns into entirely distinct grouping configurations, allowing column grouping schemes to be optimized independently for each horizontal partition based on data distribution patterns and usage characteristics. This partitioning enables dynamic optimization without requiring consistency in column grouping across different partitions.

Delta Metadata File: A metadata file created during data manipulation operations that contains file metadata and column properties for all columns, partitioned horizontally only based on groups of data rows.

Compact Metadata File: A metadata file created through the compaction process that combines multiple delta metadata files and implements both horizontal and vertical partitioning, with column groups organized according to usage patterns, size of statistics, and predefined policies.

Column Group Resolution: The process of using column group metadata to identify and load the appropriate secondary metadata file when statistics for a specific column are requested during query compilation.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A system comprising:
at least one hardware processor; and
a memory storing instructions that cause the at least one hardware processor to perform operations comprising:
receiving delta metadata files containing statistics for columns of a database table;
performing horizontal partitioning of the delta metadata files based on groups of data rows;
performing vertical partitioning of the horizontally partitioned metadata by grouping columns into a primary column group and one or more secondary column groups;
storing the primary column group in a primary metadata file that includes file metadata for data partitions and column group metadata that maps columns to column groups;
storing each secondary column group in a separate secondary metadata file;
storing the column group metadata in the primary metadata file;
receiving a query that references one or more columns of the database table;
reading the primary metadata file;
determining whether statistics for the one or more columns are available in the primary metadata file;
in response to determining that statistics for at least one referenced column are not available in the primary metadata file, using the column group metadata to identify a secondary metadata file including the statistics for the at least one referenced column;
reading the identified secondary metadata file; and
performing, using the statistics from the primary metadata file and the secondary metadata file, an optimization of the query to improve a subsequent execution of the query.

2. The system of claim 1, wherein the column group metadata comprises a dictionary structure that maps column identifiers to column group identifiers, and the operations further comprise:
generating an optimized query based at least in part on performing the optimization; and
sending the optimized query to a particular execution node for executing the optimized query.

3. The system of claim 2, wherein each column group identifier is associated with a file location reference that points to a corresponding secondary metadata file.

4. The system of claim 1, wherein the primary metadata file includes a boolean flag indicating whether all table columns are in a primary column group or distributed across multiple column groups.

5. (canceled)

6. The system of claim 1, wherein performing vertical partitioning comprises:
determining a maximum column group size; and
splitting columns into groups based on the maximum column group size.

7. The system of claim 1, wherein vertical partitioning is unaligned, allowing different horizontal partitions to have different vertical partitioning schemes.

8. The system of claim 1, wherein performing vertical partitioning comprises:
analyzing column usage patterns to identify frequently accessed columns; and
placing the frequently accessed columns in the primary column group.

9. The system of claim 6, wherein performing vertical partitioning comprises:
identifying columns that contain specialized statistics; and
placing the identified columns in dedicated special column groups.

10. The system of claim 1, wherein the secondary metadata file is a special column group metadata file containing specialized statistics that are larger in size than standard column statistics, wherein the specialized statistics comprise at least one of: HyperLogLog (HLL) sketches for distinct value estimation, N-grams for text search optimization, or Bloom filters for join optimization.

11. The system of claim 1, wherein the operations further comprise:
using the statistics to optimize execution of the query by eliminating data partitions that cannot satisfy query conditions.

12. The system of claim 1, wherein the operations further comprise:
updating column usage statistics based on columns referenced in the query; and
using the column usage statistics to determine column grouping during a subsequent metadata file compaction.

13. A method comprising:
receiving delta metadata files containing statistics for columns of a database table;
performing horizontal partitioning of the delta metadata files based on groups of data rows;
performing vertical partitioning of the horizontally partitioned metadata by grouping columns into a primary column group and one or more secondary column groups;
storing the primary column group in a primary metadata file that includes file metadata for data partitions and column group metadata that maps columns to column groups;
storing each secondary column group in a separate secondary metadata file;
storing the column group metadata in the primary metadata file;
receiving a query that references one or more columns of the database table;
reading the primary metadata file;
determining whether statistics for the one or more columns are available in the primary metadata file;
in response to determining that statistics for at least one referenced column are not available in the primary metadata file, using the column group metadata to identify a secondary metadata file including the statistics for the at least one referenced column;
reading the identified secondary metadata file; and
performing, using the statistics from the primary metadata file and the secondary metadata file, an optimization of the query to improve a subsequent execution of the query.

14. The method of claim 13, wherein the column group metadata comprises a dictionary structure that maps column identifiers to column group identifiers, and further comprising:
generating an optimized query based at least in part on performing the optimization; and
sending the optimized query to a particular execution node for executing the optimized query.

15. The method of claim 14, wherein each column group identifier is associated with a file location reference that points to a corresponding secondary metadata file.

16. The method of claim 13, wherein the primary metadata file includes a boolean flag indicating whether all table columns are in a primary column group or distributed across multiple column groups.

17. (canceled)

18. The method of claim 13, wherein performing vertical partitioning comprises:
determining a maximum column group size; and
splitting columns into groups based on the maximum column group size.

19. The method of claim 13, wherein vertical partitioning is unaligned, allowing different horizontal partitions to have different vertical partitioning schemes.

20. A non-transitory computer-storage medium comprising instructions that, when executed by one or more processors of a machine, configure the machine to perform operations comprising:
receiving delta metadata files containing statistics for columns of a database table;
performing horizontal partitioning of the delta metadata files based on groups of data rows;
performing vertical partitioning of the horizontally partitioned metadata by grouping columns into a primary column group and one or more secondary column groups;
storing the primary column group in a primary metadata file that includes file metadata for data partitions and column group metadata that maps columns to column groups;
storing each secondary column group in a separate secondary metadata file;
storing the column group metadata in the primary metadata file;
receiving a query that references one or more columns of the database table;
reading the primary metadata file;
determining whether statistics for the one or more columns are available in the primary metadata file;
in response to determining that statistics for at least one referenced column are not available in the primary metadata file, using the column group metadata to identify a secondary metadata file including the statistics for the at least one referenced column;
reading the identified secondary metadata file; and
performing, using the statistics from the primary metadata file and the secondary metadata file, an optimization of the query to improve a subsequent execution of the query.

21. The non-transitory computer-storage medium of claim 20, wherein the column group metadata comprises a dictionary structure that maps column identifiers to column group identifiers, and the operations further comprise:
generating an optimized query based at least in part on performing the optimization; and
sending the optimized query to a particular execution node for executing the optimized query.

22. The non-transitory computer-storage medium of claim 21, wherein each column group identifier is associated with a file location reference that points to a corresponding secondary metadata file.
